(19) United States
(12) Patent Application Publication
(10) Pub. No.: US 2015/0031414 A1
(43) Pub. Date: Jan. 29, 2015

(54) MICRO PROJECTOR

(71) Applicant: Hui Zhao, Guangdong (CN)

(72) Inventor: Hui Zhao, Guangdong (CN)

(21) Appl. No.: 14/381,589

(22) PCT Filed: Aug. 17, 2013
(86) PCT No.: PCT/CN2013/081707

§ 371 Date: Aug. 27, 2014

(30) Foreign Application Priority Data
Jan. 24, 2013 (CN) 2013200396743

(51) Int. Cl. H04L 12/10; G06F 13/38; H04M 1/725

(52) U.S. Cl. CPC H04L 12/10; H04M 1/72527; G06F 13/382
USPC 455/559

(57) ABSTRACT

A micro projector comprising a communication connection with a mobile terminal device via WIFI wireless network. The micro projector includes a master controller, a WIFI module configured to build the WIFI wireless network with the mobile terminal device, a USB interface configured to charge for the mobile terminal device, a USB flash drive configured to transmit data to the mobile terminal device, and a memory for storing data within the micro projector. The WIFI module, the USB interface, the USB flash drive and the memory are coupled with the master controller. Accordingly, the trouble of carrying different video data wires is eliminated, and the mobile terminal device can be also charged. The mobile terminal device can read the data stored in the internal memory of the micro projector to indirectly extend the storage capacity of the mobile terminal device. The micro projector can also be bridged to an external network.

### BACKGROUND OF THE INVENTION

The present invention relates to the field of projection technology, and more particularly, to a micro projector.

Currently, the micro projector can be divided into LCOS technology and DLP (Digital Light Processor) technology from the optical perspective of the projection modules. DLP technology has now become the mainstream of the projection optical module because of high optical efficiency, high color contrast, and good image reproduction etc. In addition, the micro projector has multiple video interfaces in the front terminal processing aspect, the micro projector is coupled to smart phones, PADs or computers via a HDMI (High Definition Multimedia Interface) cable, a MHL (MOBILE HIGH DEFINITION) data wire or other video data wires, and receives video signals through the cable to thereby project. Simultaneously, the micro projector is provided with an SD card slot for receiving an SD card, the document to be played must first be copied to the SD card, and the projector reads video files in the SD card, and then decodes and projects.

In the prior arts, the micro projector has the biggest drawback that the micro projector is connected to the different mobile terminal devices through different video data lines, in this case, the micro projector as portable products of modern life, because of the plurality of different video data lines, users need to carry a lot of different video data lines, thereby bringing inconvenience to the users. In addition, because of their own volume limitation, the built-in memory capacity and the battery capacity of the smart phones and PAD is small and low, while the existing projectors neither charge for these devices, nor provide expanded storage space, thereby limiting usage time and storage space of the projector.

### BRIEF SUMMARY OF THE INVENTION

The technical problem to be solved in the present invention lies in: aiming at the inconvenience to users and the defects for limiting usage time and storage space of the projector in the prior art, a micro projector is provided, and the technical solution not only eliminates the need for users to carry different video data lines; but also charges for the mobile terminal device and expands the storage capacity of the mobile terminal device.

In order to solve the technical problem, the technical solutions of the present invention is: a micro projector is provided, wherein the micro projector has a communication connection with a mobile terminal device via WIFI wireless network, the micro projector includes a master controller, a WIFI module configured to build the WIFI wireless network with the mobile terminal device, a USB interface configured to charge for the mobile terminal device, a USB flash drive configured to transmit data to the mobile terminal device, and a memory for storing data within the micro projector, and wherein the WIFI module, the USB interface, the USB flash drive and the memory are coupled with the master controller.

In the micro projector, preferably, the micro projector further includes a digital light processor coupled to the master controller, and after the digital light processor processes image signals from the micro projector, the digital light processor implements projection.

In the micro projector, preferably, the digital light processor is constituted by digital micro mirror components.

In the micro projector, preferably, the micro projector further includes a power manager coupled to the master controller and the digital light processor respectively and providing power for the micro projector.

In the micro projector, preferably, the data within the micro projector includes the data in the own memory of the micro projector and the transmission data from the mobile terminal device to the micro projector.

In the micro projector, preferably, an output voltage of the USB interface is 5V.

In the micro projector, preferably, the micro projector further includes a multimedia interface coupled with the master controller and providing audio and video signals.

In the micro projector, preferably, the multimedia interface includes a HDMI interface, a MHL interface and a TV interface.

In the micro projector, preferably, the micro projector further includes an Ethernet interface coupled to the master controller and establishing a wired network with the mobile terminal device.

In the micro projector, preferably, the mobile terminal device includes a smart phone, a PAD or a notebook.

To implement the technical solutions, it has the following beneficial effects: the micro projector has a communication connection to the mobile terminal device via WIFI wireless network, thus, the trouble of carrying different video data wires is eliminated for the user, and the mobile terminal device can be also charged. And, the mobile terminal device can read the data stored in the internal memory of the micro projector to thereby indirectly extend the storage capacity of the mobile terminal device. In addition, the micro projector can also be bridged to an external network.

### BRIEF DESCRIPTION OF THE DRAWINGS

In conjunction with an accompanying drawing and the following embodiments, the present invention will be further illustrated, and in the accompanying drawing:

FIG. 1 is a schematic diagram of a micro projector in accordance with an embodiment of the present invention.

### DETAILED DESCRIPTION OF THE INVENTION

To make the objectives, technical solutions and advantages of the present invention clearer, the present invention will be further described hereafter with reference to the accompany drawings and embodiments. It shall be understood that, the embodiments described herein are only intended to illustrate but not to limit the present invention.

In this embodiment, a micro projector acting as a mobile portable device is connected with mobile terminal devices via WIFI wireless network communication, and it not only eliminates the troubles for users to carry different video cable, but also indirectly extends the storage capacity of the mobile terminal devices since the mobile terminal devices can read the data stored in a memory in the micro projector. In addition, the micro projector may be bridged to an external network. The mobile terminal device includes a smart phone, a PAD or a notebook.

It should be noted that the micro projector with WIFI display function and WIFI storage function, and it is worth noting that the WIFI display function and WIFI storage function can be used as an external part, that is to say, these two functions may not be integrated with the micro projector. The WIFI display function is carried out when the mobile terminal device transmits stored pictures, documents and videos and other data via WIFI wireless network to the micro projector to project thereon, after the micro projector is connected with the mobile terminal device via WIFI wireless network. The WIFI storage function is carried out when the mobile terminal device transmits stored pictures, documents and videos and other data via WIFI wireless network to the memory in the micro projector to store therein, or the data in the memory in the micro projector is copied to the mobile terminal device to operate, after the micro projector is connected with the mobile terminal device via WIFI wireless network. In this embodiment, the mobile terminal device may be used for a remote controller which controls the micro projector via WIFI wireless network.

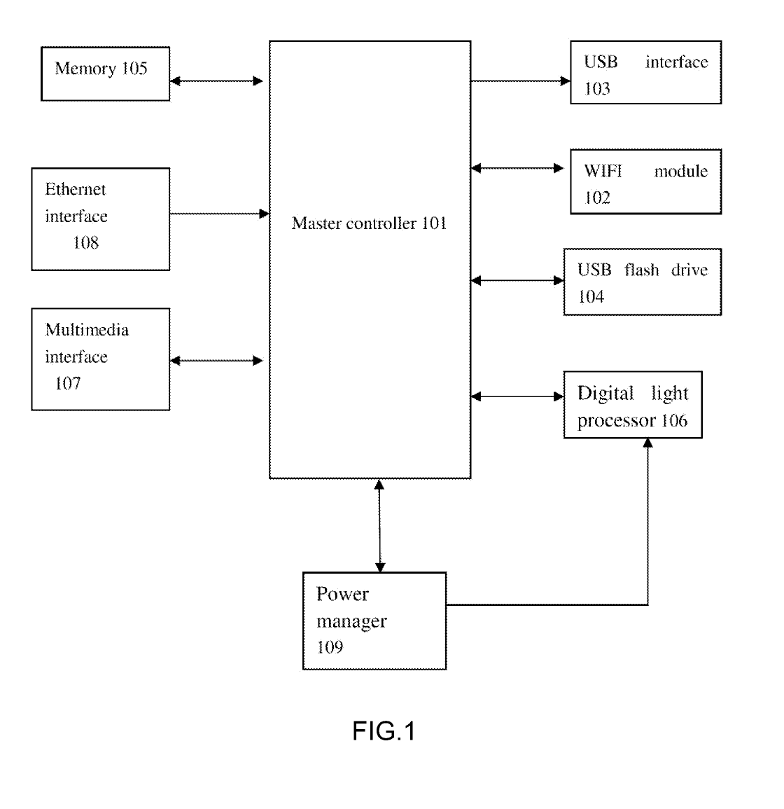

Referring to FIG. 1, FIG. 1 is a schematic diagram of the micro projector in accordance with the embodiment of the present invention. The micro projector includes a master controller 101, a WIFI module 102, a USB interface 103, a USB flash drive 104, a memory 105, a digital light processor 106, a multimedia interface 107, and an Ethernet interface 108 coupled to the master controller 101, respectively, and a power manager 109 coupled to the master controller 101 and the digital light processor 101, respectively.

The following describes the function of each part:

The master controller 101 acts as a core part of the micro projector, and the master controller 101 uses the chip SSD1937 is used in this embodiment.

The WIFI module 102 is established a WIFI wireless network with the mobile terminal device, and the WIFI module 102 uses the chip RTL8188C in this embodiment.

The USB interface 103 is used to charge for the mobile terminal device, in the present embodiment, the output voltage of the USB interface 103 is 5V, specifically, the USB interface 103 charges for the mobile terminal device via a wire of a charger.

The USB flash drive 104 transmits data to the mobile terminal device each other, in the present embodiment, the USB flash drive 104 uses the chip SM3261.

The memory 105 is used for storing the data within the micro projector, wherein the data within the micro projector includes the data in the own memory of the micro projector and the transmission data from the mobile terminal device to the micro projector.

The digital light processor 106 is configured to process the image signal from the micro projector and then carry out projection, wherein the digital light processor 106 is constituted by a digital micro mirror component and the digital light processor 106 uses the chip DPP2607 in the present embodiment.

The multimedia interface 107 provides audio and video signals, wherein the multimedia interface 107 includes a HDMI interface, a MHL interface and a TV interface, and the multimedia interface 107 uses the chip EP94Z3 in this embodiment.

The Ethernet network interface 108 and the mobile terminal device establish a wired network.

The power manager 109 provides power to the micro projector.

It should be noted that the above-mentioned are independent parts of the configuration, and the person skilled in the art should be understood that other chips may be used by the master controller 101 and other parts in other embodiments, and it does not repeat herein.

Compared with the prior arts, the micro projector has a communication connection to the mobile terminal device via WIFI wireless network, thus, the trouble of carrying different video data wires is eliminated for the user, and the mobile terminal device can be also charged. And, the mobile terminal device can read the data stored in the internal memory of the micro projector to thereby indirectly extend the storage capacity of the mobile terminal device. In addition, the micro projector can also be bridged to an external network.

What described above are only preferred embodiments of the present invention but are not intended to limit the scope of the present invention, for the skilled in the art, any modifications, equivalent replacements and improvements etc. made within the spirit and principle of the present invention, should be included in the protection scope of the present invention.

1. A micro projector, wherein the micro projector has a communication connection with a mobile terminal device via WIFI wireless network, the micro projector comprises a master controller, a WIFI module configured to build the WIFI wireless network with the mobile terminal device, a USB interface configured to charge for the mobile terminal device, a USB flash drive configured to transmit data to the mobile terminal device, and a memory for storing data within the micro projector, and wherein the WIFI module, the USB interface, the USB flash drive and the memory are coupled with the master controller.

2. The micro projector according to claim 1, wherein the micro projector further comprises a digital light processor coupled to the master controller, and after the digital light processor processes image signals from the micro projector, the digital light processor implements projection.

3. The micro projector according to claim 2, wherein the digital light processor is constituted by digital micro mirror components.

4. The micro projector according to claim 2, wherein the micro projector further comprises a power manager coupled to the master controller and the digital light processor respectively and providing power for the micro projector.

5. The micro projector according to claim 1, wherein the data within the micro projector comprises the data in the own memory of the micro projector and the transmission data from the mobile terminal device to the micro projector.

6. The micro projector according to claim 1, wherein an output voltage of the USB interface is 5V.

7. The micro projector according to claim 1, wherein the micro projector further comprises a multimedia interface coupled with the master controller and providing audio and video signals.

8. The micro projector according to claim 7, wherein the multimedia interface comprises a HDMI interface, a MHL interface and a TV interface.

9. The micro projector according to claim 1, wherein the micro projector further comprises an Ethernet interface coupled to the master controller and establishing a wired network with the mobile terminal device.

10. The micro projector according to claim 1, wherein the mobile terminal device comprises a smart phone, a PAD or a notebook.

11. The micro projector according to claim 2, wherein the mobile terminal device comprises a smart phone, a PAD or a notebook.

12. The micro projector according to claim 3, wherein the mobile terminal device comprises a smart phone, a PAD or a notebook.

13. The micro projector according to claim 4, wherein the mobile terminal device comprises a smart phone, a PAD or a notebook.

14. The micro projector according to claim 5, wherein the mobile terminal device comprises a smart phone, a PAD or a notebook.

15. The micro projector according to claim 6, wherein the mobile terminal device comprises a smart phone, a PAD or a notebook.

16. The micro projector according to claim 7, wherein the mobile terminal device comprises a smart phone, a PAD or a notebook.

17. The micro projector according to claim 8, wherein the mobile terminal device comprises a smart phone, a PAD or a notebook.

18. The micro projector according to claim 9, wherein the mobile terminal device comprises a smart phone, a PAD or a notebook.

19. The micro projector according to claim 3, wherein the micro projector further comprises a power manager coupled to the master controller and the digital light processor respectively and providing power for the micro projector.
